(19) United States
(12) Patent Application Publication
(10) Pub. No.: US 2006/0072073 A1
(43) Pub. Date: Apr. 6, 2006

(54) Method for producing and exhibiting three-dimensional motion pictures from a single strip of motion picture film

(76) Inventor: Robert C. Weisgerber, New York, NY (US)

Correspondence Address: DAVID PETER ALAN, ESQ., 81 Second St., South Orange, NJ, 07079, US

(21) Appl. No.: 10/649,434

(22) Filed: Aug. 28, 2003

(51) Int. Cl. G03B 21/32

(52) U.S. Cl. 352/86

(57) ABSTRACT

A method is disclosed for producing and exhibiting high-quality three-dimensional (3-D) motion pictures. Stereoscopic images are placed side by side on a strip of motion picture film, such images having been anamorphically compressed to fit into the 70 mm or other film format used for presentation. These images are then reciprocally expanded to produce the aspect ratio of the original images as photographed. A single strip of motion picture film is used and images intended to be seen through the left or right eye of the viewer of such films are slightly different, to create the 3-D effect. To minimize the amount of light projected onto the screen, projection is accomplished by use of a projector capable of accomplishing pulldown between frames in five milliseconds of less and equipped with a single 0-bladed shutter at high frame rates, specifically 48 frames per second or higher. The method described here allows for screen sizes considerably larger than those currently in use for theatrical 3-D presentation. Viewers of films produced by this method can observe the images projected through polarized glasses or by other means known in the art. The 3-D effect can be withdrawn as desired by presenting identical images for the right and left eyes, thus delivering two-dimensional (2-D) presentation. Existing 3-D movies can be converted for exhibition according to the method described, with significant improvement in picture quality and smoother appearance of motion. In addition, films can be made to deliver 3-D effect for certain scenes or sequences within a motion picture presentation, with 2-D presentation for other scenes or sequences within the same motion picture.

### BACKGROUND OF THE INVENTION

This Invention relates to motion pictures exhibited to audiences in a manner that simulates three-dimensional (3-D) viewing. There have been a number of systems in use for photographing and showing 3-D films but each possessed undesirable qualities, with which the present system is not hampered.

The earliest 3-D movies were photographed in black-and-white and projected through red and green filters. Viewers wore glasses for viewing such films; the glasses consisting of a red lens in front of one eye and a green lens in front of the other eye. In this manner, the viewer saw one image through the left eye and a slightly different image through the right eye. The difference in images was just enough to replicate parallax differences between the two eyes of the viewer, and to make it appear as though the screen were located at the point of convergence of the left-eye and right-eye vision. Clearly, the chromatic aberrations inherent in use of red and green filters limited the use of that system.

More modem methods make use of polarized light (passive system) to distinguish between images for the left eye, and those for the right eye, or of a method for briefly and alternately covering the eyes of the viewer (active system), so that only one eye is actually viewing a film image at any given instant. Other inventions in this field (e.g. McCormack, U.S. Pat. No. 3,482,098 (1969)) discloses (but does not claim) presentation to viewers without the glasses typically associated with 3-D motion picture presentation. In the invention described, any means by which the viewers of a motion picture film can observe the 3-D effect (with or without such glasses and light polarization) is acceptable in the practice of the invention described. The invention described produces a high-quality 3-D presentation to viewers sitting anywhere in the theater, including seats at the sides of the auditorium.

Three-dimensional presentation can be accomplished using a single projector and a single strip of film, or two projectors (whether as two totally separate machines or on a single transport), showing separate film images for the left and right eyes, respectively. An example of a two-projector system currently in use is the IMAX 3-D presentation method. Such a presentation method has several inherent drawbacks, among them difficulty in synchronizing images, expense of special projection systems and use of large quantities of film. The invention described here uses a single projector and a single strip of motion picture film.

Other single-projector presentation methods have their own drawbacks. Lipton, U.S. Pat. No. 5,481,321 (1992) uses a format where the two images of each frame of film are placed one above the other. This “over and under” format produces an extremely wide image, which is undesirable. In Lipton 321, a sophisticated system of optics, including prismatic lenses situated at right angles, is needed to converge the two adjacent images, each of which is intended to be seen by one eye of the viewer. See also Ohno, U.S. Pat. No. 4,544,247 (1985) (prismatic optics). McCormack 908 also features a complex optical system for splitting a single image into left-eye and right-eye views. In all of the above inventions, a large amount of light is lost in the optics required to produce the 3-D presentation effect, with the result that image brightness suffers. The invention described herein does not have this problem, since more light is delivered to the viewers than in the other systems mentioned. It is an objective of the present invention, then, to maximize the amount of light delivered to the viewers of the motion pictures presented in the practice of the invention herein.

Another drawback of current 3-D presentation methods is that they are always “on” and the 3-D effect cannot be withdrawn to yield two-dimensional (2-D) presentation for part of the film being produced. The sophisticated optical components of the above-cited inventions cannot be turned “off” for part of a presentation. Bernier, U.S. Pat. No. 2,478,891 (1949) teaches an attachment that can be retrofitted onto a conventional projector to show 3-D films. In the practice of Bernier's invention, it was not feasible to show both 3-D and 2-D presentation without significant effort. Moreover, 2-D presentation was undesirable because there was insufficient light to deliver a satisfactory 2-D image to the audience. The amount of light delivered by the present invention cures this difficulty. It is, therefore, a further objective of the present invention to allow compatibility of 3-D and 2-D presentation within a single motion picture.

The system described here solves the problems inherent in other systems currently in use for 3-D motion picture presentation. While a large-format, two-projector system such as IMAX presents images of extremely high quality, the IMAX system is very expensive to install and operate, and is incompatible with conventional motion picture theater equipment and operations. Therefore, its use is limited to a small number of special venues. Current single-filmstrip systems are less expensive, but none can deliver the resolution or screen brightness available with the invention described here. Moreover, all systems currently in use exhibit films at 24 frames per second, thereby retaining flicker and stroboscopic effects, two highly undesirable artifacts. Stroboscopic effects are particularly degrading to picture quality in 3-D presentation. Since the system described here uses a higher frame rate, these artifacts are not present in the practice of the invention. At 48 frames per second, the preferred projection speed for the invention described, motion appears much smoother, due to the presence of 48 discrete images during each second of presentation. Jutter is also significantly reduced. This apparent smoothness of motion available at the high frame rates recommended for use with this invention enhances the 3-D effect upon the viewers of the films being shown, and provides an especially noticeable improvement on large screens.

The invention described here solves many of the problems inherent in current 3-D exhibition systems. As shall be shown, more light is projected onto the screen than in conventional systems, so the viewers in the audience experience a brighter presentation. The additional light available in the system described also allows a better 2-D presentation for scenes or sequences when the 3-D feature is not desired. Moreover, the increased light brightness available with the present invention allows a significantly brighter image to be projected over a larger screen than head heretofore been possible.

### BRIEF DESCRIPTION OF THE INVENTION

In the practice of the invention herein, motion pictures are produced to deliver the three-dimensional effect to the viewers of those pictures. Motion picture images are photographed or prepared by any method currently known in the art. Stereoscopic images can be photographed by using two film or video cameras, spaced an appropriate distance apart. In the preferred embodiment of the invention, 48 discrete images are captured for each second of presentation. However, films originally produced for 24 frame-per-second presentation can be converted for exhibition according to this invention to deliver an image to the audience that constitutes an improvement over the image as previously captured as part of the original motion picture.

Images are placed side by side on the film frame, similar to placement in stereoscopic still picture (print or slide) viewers. In the preferred embodiment of the invention, the 70 mm film format (65 mm width of the actual camera image, with five perforations per frame) is used. Other formats, such as 35 mm, can be used to advantage over conventional 3-D presentation, but the results will not be as desirable as with the 70 mm format. An appropriate amount of anamorphic compression, typically in the horizontal direction, is imparted to each image to fit it into one half of the image space available in the film format to be used. In the preferred embodiment of the invention, images are recorded wit the 65/70 mm format aspect ratio if 2.21:1. Either two separate cameras or a single camera can be used to capture separate left-eye and right-eye images. These images are anamorphically compressed in the horizontal direction (either optically or through computer techniques) to fit side by side into 70 mm film format with five perforations per frame. In effect, the images are squeezed to half their original size for printing onto film. The process is also compatible with other aspect ratios used n wide-screen theatrical motion picture production and exhibition as wide as 2.4:1. Although the nominal aspect ratio of the 70 mm film format is 2.21:1, the use of that film size without recording audio information at the outer edges permits an aspect ratio of 2.4:1, using the entire available area.

The images that had been compressed to fit them onto the film are reciprocally expanded on projection. In the practice of the invention herein, the film is projected at a high frame rate; 48 frames per second in the preferred embodiment. Other frame rates, such as 50 or 60 frames per second, can be used, but projection at a rate of at least 48 frames/sec. is necessary to achieve the desired effect. The projector must be capable of fast pulldown, so that only five milliseconds or less is needed for pulldown of each frame. This means that only one quarter of each frame cycle is needed for pulldown, so the blade of the shutter must only block light for one quarter of the duration of each frame. Thus, more light can hit the screen than can be delivered with the conventional double-bladed shutter. A single-bladed shutter is used in the practice of the invention described. The present system allows light to be projected for 270 degrees of shutter rotation for each cycle, when conventional systems with a double-bladed shutter and standard pulldown (required ten milliseconds or longer) allow light to be projected for only 180 degrees of shutter rotation. Therefore, the light is “on” for a much greater portion of the projection of each frame than had previously been feasible. This extra light allows for the dispersion of some light due to projection optics and polarization, while still delivering to the audience a significantly brighter screen image than is available with 3-D presentation systems currently in commercial use, when a silver screen is used as part of the exhibition system.

The invention described here can also be used to selectively deliver the 3-D effect, or withdraw it to deliver conventional 2-D effect within a single motion picture. For scenes where the 3-D effect is not desired, the identical image can be prepared for left-eye and right-eye viewing, and the two identical images positioned beside each other in the same film frame. In this manner, the “3-D” effect can be used for the presentation of only certain selected scenes or sequences in a motion picture. Opposite polarization of left-eye and right-eye images, as known in the art, can be practices with the invention described here.

### BRIEF DESCRIPTION OF THE DRAWINGS

FIG. 1 shows two images on frames of motion picture film.

FIG. 2 shows two images on a frame of motion picture film in the 65/70 mm format, with the images shown as they would be positioned in the format proposed in the invention described.

FIG. 3 shows a schematic representation of the system used for projection of three-dimensional motion picture films according to the invention described.

### DETAILED DESCRIPTION OF THE INVENTION

The invention described comprised both a method for storing motion picture film images, and a method for projection of such images, with the result that the three-dimensional (3-D) effect delivered to persons viewing such films is brighter and more realistic than is now possible with conventional 3-D systems. Capture and preparation of images is separate from projection of images in the system described, although both are necessary for the system to work properly.

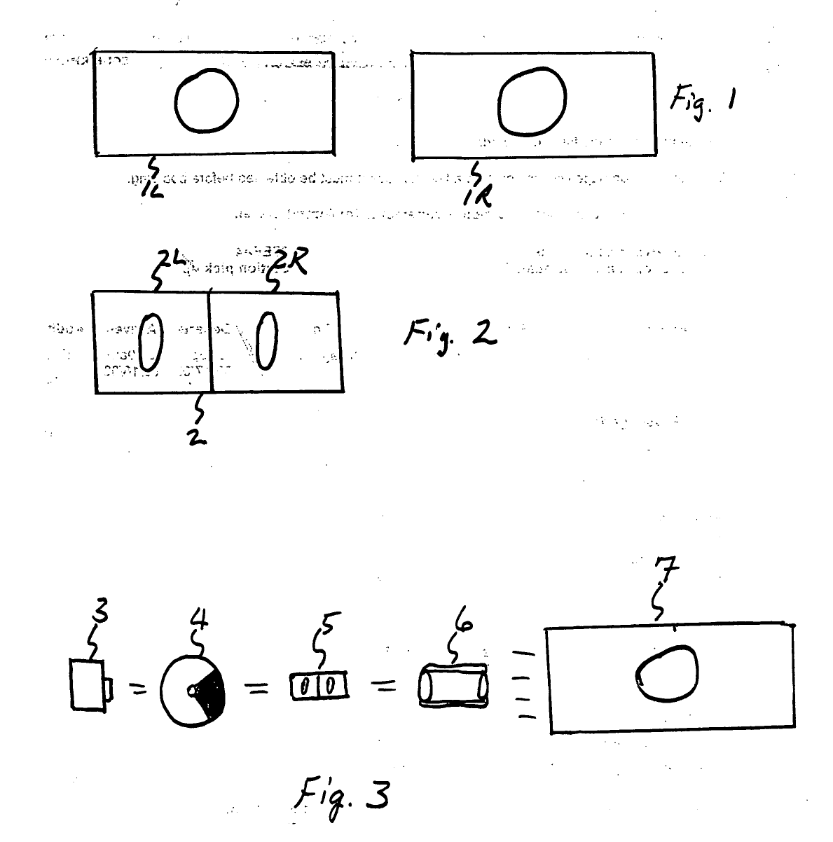

Turning to the “capture” side first, film images are photographed or otherwise prepared n the 65/70 mm film format as shown in FIG. 1. Images 1L and 1R take up the entire film frame, which features a nominal aspect ratio of 2.21:1 and can accommodate an aspect ratio as wide as 2.4:1, and contains five perforations (not shown) per frame. Films recorded in other aspect ratios (such as 1.85:1) can be converted to the 65/70 mm format optically or by computerized imaging techniques known in the art. For original films produced for exhibition according to the invention described, photography can be accomplished using two film or video cameras spaced an appropriate distance apart to capture separate imaged for the left and right eyes of the persons viewing the film. This type of 3-D photography is known in the art. Alternatively, films can be photographed by a single camera storing images in an “over and under” format, with those images converted to “side by side” placement on the film frame as part of postproduction by using optical or computerized imaging techniques.

The resulting left-eye and right-eye images are stored onto a single strip of 70 mm film for exhibition. The images are stored side by side, as shown in FIG. 2. Here, the images seen in FIG. 1 have been duplicated, and images 2L (for the left eye) and 2R (for the right eye) are placed onto the film frame. In original films photographed through two cameras, or one camera using the “over and under” technique, the discrete left-eye and right-eye images are stored as seen in FIG. 2. These resulting images are anamorphically compressed to fit them into the 70 mm film format. In effect, each image is squeezed horizontally to one half of its original width, to be stretched back to its original aspect ratio upon projection. For films produced in other aspect ratios, optical or computerized techniques known in the art can be used to convert the original images into the 70 mm format, for compression and storage onto the film frames as described. It should be noted that films produced in such nonstandard high-impact formats as IMAX (70 mm with 15 perforations per frame, traveling horizontally) can be converted into the 70 mm format with aspect ratios as wide as 2.4:1, with image reformatting for wide-screen presentation, and exhibited according to the invention described. Such exhibition is compatible with conventional theater systems and operations, rather than being limited to special venues. This greatly expands the potential available audience for such films, and presents them in a manner that is vastly superior to conventional theater exhibition.

In the preferred practice of this invention, motion pictures produced to be shown in accordance with it are photographed at a frame rate of at least 48 frames per second. This rate is also used for exhibition in the preferred practice of the invention. Stroboscopic effects are more pronounced in 3-D presentation than in 2-D presentation and photographing 48 discrete images per second significantly reduces these undesirable effects. Higher frame rates, such as 50 or 60 frames per second, for image capture and exhibition at the same frame rate are suitable. However, 48 frames per second is the preferred frame rate, because it is most compatible with the 24 frames per second rate associated with conventional motion picture production and exhibition. The benefits of projection at these higher frame rates have been previously demonstrated by the inventor herein; (Weisgerber, U.S. Pat. No. 5,637,614 (1997) and U.S. Pat. No. 6,243,156 (2001) (48 fps); and U.S. Pat. No. 5,739,894 (1998) (other frame rates)).

For films previously produced, conversion requires production of extra images by computerized techniques. Films photographed or other wise prepared at 24 frames per second can be converted for exhibition at 48 frames per second by computerized synthesis of “in-between” images to be interposed between each successive film image as originally photographed or otherwise produced. This can be accomplished by using Kodak “Cineon” software, a digital intermediate process. In effect, this conversion method produces 48 “discrete” images for display during each second, to be further treated as described for 3-D presentation to motion picture audiences. Another conversion method comprises the double-frame printing of films produced for exhibition at twenty-four frames per second without the synthesized “in between” images. This method is technically feasible, although it does not deliver the full benefit available with this invention.

For presentation of films according to the invention described, a single strip of motion picture film is projected at a high frame rate (48 frames per second or faster) through a projector equipped with a single-bladed shutter. The projector used must be capable of rapid pulldown of film between frames to minimize blanking time and minimize the portion of the frame cycle when light is projected onto the screen.

FIG. 3 shows film projection schematically. A motion picture projector contains light source 3, which emits light. The light shines through shutter 4 and film frame 5, eventually hitting screen 7 and projecting the images contained on film frame 5 thereupon. It should be noted that film frame 5 is only one of many frames which comprise the motion picture feature film produced and exhibited according to the invention described. Between film frame 5 and screen 7 is lens 6. Lens 6 contains the optical elements which customarily form a projection lens for 3-D projection (including optics for offsetting left-eye and right-eye images) and, additionally anamorphic expansion elements which serve to expand the images on the film to the aspect ratio of 2.21:1 normally used in the 70 mm film format.

In the preferred embodiment of the invention, screen 7 is a metallic silver screen, preferably capable of delivering a screen gain of 2, to increase screen image brightness and maintain polarity of film images intended for the left or right eyes of the viewers of the films.

A vital feature of the invention is shutter 4, which is single-bladed and dynamically balanced for smooth rotation. A single-bladed shutter is used in the invention to increase the brightness of the image displayed on screen 7, as will be described.

The projector must be capable of pulling down the film between frames more quickly than the conventional Geneva-movement projectors can accomplish. Projectors are currently available that can accomplish film pulldown in five milliseconds or less. An example is a dual-intermittent projector manufactured by the Ballentine Cinema Corp. of Omaha, Nebraska under the brand name Megasystem. The projector used in the practice of the invention can accomplish pulldowni half the time required by conventional projectors, thereby allowing 50% more light to reach the screen. Films are projected at 48 frames per second (in the preferred embodiment) or a higher frame rate, if pulldown can be accomplished sufficiently quickly. At 48 frames per second, the cycle for each frame lasts for approximately 20 milliseconds. With film pulldown lasting five milliseconds, this comprises one quarter of the cycle. The blade of shutter 4 covers 90 degrees of arc, blocking light during the time required for pulldown. Light is allowed to pass through the open portion of the shutter for the other three quarters of the cycle.

Conventional projection at 24 frames per second requires a double-bladed shutter to reduce flicker to acceptable levels. The drawback of the double-bladed shutter is that the screen is light for only half of the time, and dark for the other half of the time. With the invention described here, persons viewing the film sown in accordance with the invention still see 48 flashes of light each second, thereby also reducing flicker to acceptable levels. Since 48 discrete images (either photographed or synthesized) are shown every second, the second blade of the shutter is not needed, and light can be permitted to hit the screen for three-quarters of the time. This represents a 50% increase in light over that delivered with a light source generating the same amount of power, but through a double-bladed shutter. Of course, if projectors capable of even faster pulldown become available, blanking time can be reduced and light can be displayed for a greater portion of the frame cycle. For example, if pulldown could be accomplished in four milliseconds, only 20% of the cycle (a shutter blade covering 72 degrees of arc) would be required for blocking light, and the other 80% of the cycle could be used for image display.

With this invention, a far greater amount of light can be delivered to the viewer than had heretofore been feasible for single-strip 3-D presentation. Brightness at this level delivers two major benefits. First, the significantly brighter images obtainable with the invention can brighten a larger screen than could previously be used for single-strip 3D presentation. Screens between 45 and 60 feet wide can be used for 3-D presentation with the invention described. Moreover, the polarized glasses used by the viewers of films presented in 3-D use up a certain amount of light in the polarizing filters placed in those glasses. Combining the light losses in projection and polarization with the gain available with a silver screen, the level of light delivered to the audience delivers resolution quality and light brightness comparable to high-quality spherical (flat) 2-D presentation. Reflected light at levels of up to eighteen footlamberts can be achieved.

An added feature of the invention described here is that 3-D presentation can be combined with two-dimensional (2-D) presentation within a single motion picture. For portions of the film intended to be shown in 2-D, the identical image can he placed on both sides of the film frame and presented to both eyes of the viewers of the film. The 3-D effect can be imparted only for certain scenes or for certain sequences within a film, as desired by the maker of that film. In effect, the 3-D presentation is only “on” when it is desired to advance the story line of the film, and not all the time. The image quality and brightness associated with the invention deliver so much clearer and brighter an image to the audience that significant portions of a film can be presented in 2-D without sacrificing image quality as seen by the audience.

To summarize the benefits of the present invention, it involves the presentation of motion pictures with a three-dimensional effect on a single strip of film, at a frame rate of at least 48 frames per second, on a projector which accomplishes pulldown in five milliseconds or less, through a single-bladed shutter. The use of a single strip of film locks in image displacement, thus avoiding difficulties with image convergence and artifacts that can be caused by such difficulties. The high frame rate and single-bladed shutter improve light display to present a more vivid image than has previously been available, and prevents eyestrain among the viewers of the film. The high frame rate also reduces stroboscopic artifacts. The increased brightness of the image allows a large screen to be employed, than had heretofore been feasible, without losing the benefits of 3-D presentation.

The method described can also serve as a “universal” format for 3-D presentation, by allowing for conversion of previously-produced films into 3-D, in addition to providing an improved 3-D presentation for original motion pictures, intended to be sown according to the invention described. It is compatible with conventional motion picture theater design and operations, and is not limited to special venues. It also provides for conversion of films made in other film formats into the 70 mm film format (or even formats such as 35 mm, with some reduction of benefits, compared to 70 mm presentation). The preferred embodiment of the invention, as described, should be thought of as illustrative and not limiting. Other embodiments are possible and should be considered as lying within the scope of the invention.

The invention claimed is:

1. A method for producing and exhibiting motion pictures to produce a three-dimensional effect upon the viewers of said motion pictures, said method comprising:
a. photographing or otherwise preparing stereoscopic images for combination into motion picture films;
b. storage of such images onto successive frames of motion picture film, with an image intended to be seen by the left eye of each of said viewers placed side-by-side with a complimentary image intended to be seen by the right eye of each of said viewers;
c. preparation of motion picture films with images stored according to the format described for motion picture exhibition on single strips of motion picture film;
d. exhibition of said motion picture films through a motion picture projector at a frame rate higher than that employed in conventional motion picture exhibition systems and through a single-bladed shutter, said projector also being capable of pulldown of film between frames at a faster speed than that employed by conventional motion picture projectors.

2. The method as in claim 1, where said images are stored onto said films in the 70 mm film format at an aspect ratio as wide as 2.4:1 or narrower, and five perforations per frame.

3. The method as in claim 2, in which such images are anamorphically compressed for storage onto said film frames and anamorphically expanded upon projection to resume the aspect ratio in which said images were originally recorded.

4. The method as in claim 1, where projection of said motion picture films proceeds at the rate of forty-eight or more frames per second.

5. The method as in claim 4, in which projection of said motion picture films proceeds at a rate selected from the group consisting of forty-eight, fifty or sixty frames per second.

6. The method as in claim 1, where the blade of said shutter subtends ninety degrees of arc or less.

7. The method as in claim 1, where the time required for pulldown between frames of said films is five milliseconds or less.

8. The method as in claim 1, where film images originally photographed or otherwise prepared in aspect ratios other than those intended for exhibition of said films are converted by anamorphic compression or expansion to the aspect ratio at which said films are exhibited, for storage on said film frames.

9. The method as in claim 1, further comprising the conversion of motion picture films originally photographed at twenty-four frames per second for exhibition according to the method described in claim 1, in which synthesized motion picture images are interpolated between frames of the motion picture as originally produced.

10. The method as in claim 9, in which such synthesized motion picture images depict a state of appearance approximately halfway between the appearance of the previous image and the appearance of the next image in sequence.

11. The method as in claim 10, in which such synthesized motion picture images are formulated by using computerized image techniques.

12. An apparatus for projection of motion pictures for delivery of a three-dimensional effect upon the viewers of said pictures in theaters designed for exhibition of said motion pictures, comprising a light source, a single-bladed shutter, a means for accomplishing pulldown of films from one frame to the next fame in succession in five milliseconds of less, and a means for projection forty-eight or more frames of motion picture film during each second.

13. The apparatus as in claim 12, further comprising a metallic screen upon which said motion picture images are projected.

14. The apparatus as in claim 13, in which said screen features a gain of a factor of two or more.

15. A method for producing and exhibiting motion pictures to deliver a three-dimensional effect to the viewers of said motion pictures, where the improvement comprises the exhibition of said pictures at a frame rate of at least forty-eight frames per second, through a single-bladed shutter, on a projector capable of accomplishing pulldown of film from one frame to the next in five milliseconds or less, onto a screen with a gain of at least a factor of two.
